(19) United States
(12) Patent Application Publication
(10) Pub. No.: US 2026/0258878 A1
(43) Pub. Date: Sep. 3, 2026

(54) PRESSURE VALVE PROVIDED WITH A ROTARY VALVE MEMBER

(71) Applicant: Safran Aerosystems, Plaisir (FR)

(72) Inventors: Sylvain Rossi, Moissy-Cramayel (FR); Pierre-Yves Loubet, Moissy-Cramayel (FR); Florian Vendel, Moissy-Cramayel (FR)

(21) Appl. No.: 18/881,651

(22) PCT Filed: Jul. 17, 2023
(86) PCT No.: PCT/EP2023/069811

§ 371 Date: Jan. 6, 2025

(30) Foreign Application Priority Data
Jul. 20, 2022 (FR) FR2207416

(51) Int. Cl. F16K 17/04; F16K 31/528

(52) U.S. Cl. CPC F16K 17/0413; F16K 31/528

(57) ABSTRACT

Disclosed is a pressure valve comprising:
a body having
   a fluid inlet opening and
   a fluid discharge opening
a valve member provided with a stem mounted movably in an axial direction with respect to the body between
   a closed position, in which the valve member bears against a valve seat, and
   an open position, in which the valve member is moved away from the valve seat.

More specifically, the pressure valve further comprises at least one fin arranged upstream of the valve member and intended to generate rotation of the valve member when a fluid passes from upstream to downstream through the body from the fluid inlet opening towards the fluid discharge opening.

The present invention relates to a pressure valve provided with a rotary valve member. The invention may be implemented with pipes in which any type of fluid circulates, such as a gas and/or a liquid. The invention finds a particularly advantageous, but not exclusive, application with aeronautical pipes in which air and/or fuel circulate.

In a manner known per se, a spring-loaded pressure valve comprises a body having a fluid inlet opening and a fluid discharge opening. The pressure valve also comprises a guide and a valve member provided with a rod mounted so as to move in translation relative to the guide between a closed position in which the valve member bears against a valve member seat and an open position in which the valve member is spaced from the valve member seat. A return spring between the guide and the valve member urges the valve member against the valve member seat in the closed position. A calibration of the return spring permits to define a pressure threshold beyond which the pressure valve switches to the open position. However, at low fluid flow rates, the partial opening of the valve member generates significant pressure losses.

Furthermore, for certain operating points, it is observed that the valve member is instable and is submitted to an oscillating regime at frequencies of up to 60 Hz. Such oscillations are likely to cause premature wear, even breakage of the internal components of the pressure valve.

The invention aims to effectively remedy the aforementioned drawbacks by proposing a pressure valve comprising:
a body having a fluid inlet opening and a fluid discharge opening, and
a valve member provided with a rod mounted so as to move in an axial direction relative to the body between a closed position in which the valve member bears against a valve member seat and an open position in which the valve member is spaced from the valve member seat.

Furthermore, the pressure valve further comprises at least one fin upstream of the valve member for causing the valve member to rotate when a fluid passes from upstream to downstream through the body from the fluid inlet opening to the fluid discharge opening.

The invention thus permits, thanks to the integration of one or more fins, to generate a torque at the rod of the valve member in order to force the valve to fully open and maintain it in the fully open position. The pressure valve is fully opened right from the lowest flow rates, which reduces pressure losses in such an operating zone. In addition, the fins, which do not disturb the fluid flow, make it possible to avoid any unstable operating regime of the valve member.

According to various embodiments of the invention, the pressure valve may comprise
a plurality of fins angularly spaced from each other in a regular manner, and/or
a guide fixed in translation relative to the body and comprising a guiding device for guiding the valve member relative to the guide along a specific trajectory, in particular a helical trajectory, so as to transform the rotational movement of the valve member into an axial displacement.

Furthermore, the guiding device may comprise at least one finger mechanically linked to one of the elements selected from the rod of the valve member and the guide, the finger cooperating with a guiding groove, in particular of helical shape, made in the other of the elements selected from the rod of the valve member and the guide.

Furthermore, according to the invention, the pressure valve may be such that:
the fin is carried by a pin arranged or fixed on a face of the valve member facing the fluid inlet opening;
the pressure valve comprises a plurality of vanes arranged on an outer periphery of the guide;
each vane has a notch allowing the passage of a ring aimed to cooperate with a circumferential groove of corresponding shape made in an internal face of the body so as to keep the guide fixed in translation relative to the body;
the guide carries a support against which one end of the return spring bears, in particular axially between the guide and the valve member;
the body has interfaces for the fixation to a structural element; and/or
the pressure valve is made from a metallic material, especially aluminum.

Of course, the different characteristics, variants and/or embodiments of the present invention can be associated with each other in various combinations insofar as they are not incompatible with or exclusive of one another.

The invention will be better understood and other characteristics and advantages will appear by reading the following detailed description, which includes embodiments given for illustrative purposes with reference to the accompanying figures, presented as way of non-limiting examples, which may serve to complete the understanding of the present invention and the description of its implementation and eventually contribute to its definition, wherein:

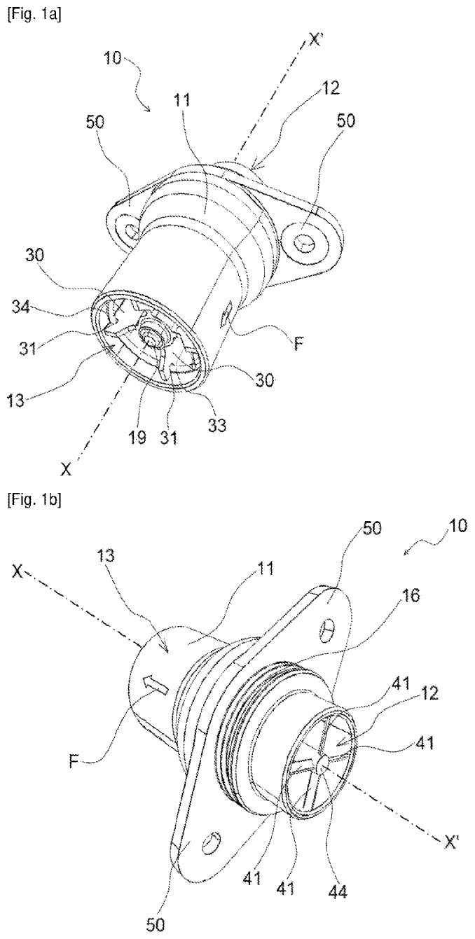

FIGS. 1a and 1b are perspective views from two different angles of the pressure valve according to the present invention;

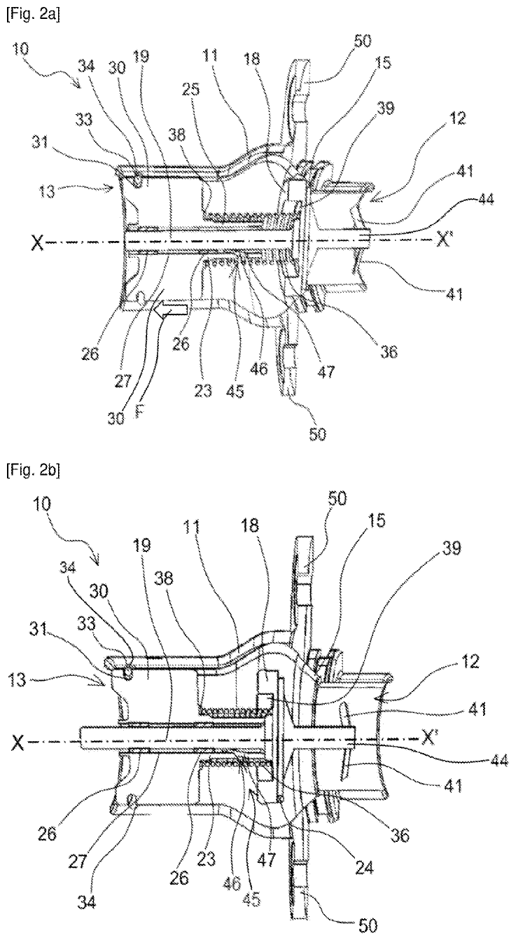

FIGS. 2a and 2b are longitudinal sectional views of a pressure valve according to the invention respectively in a closed position and in an open position;

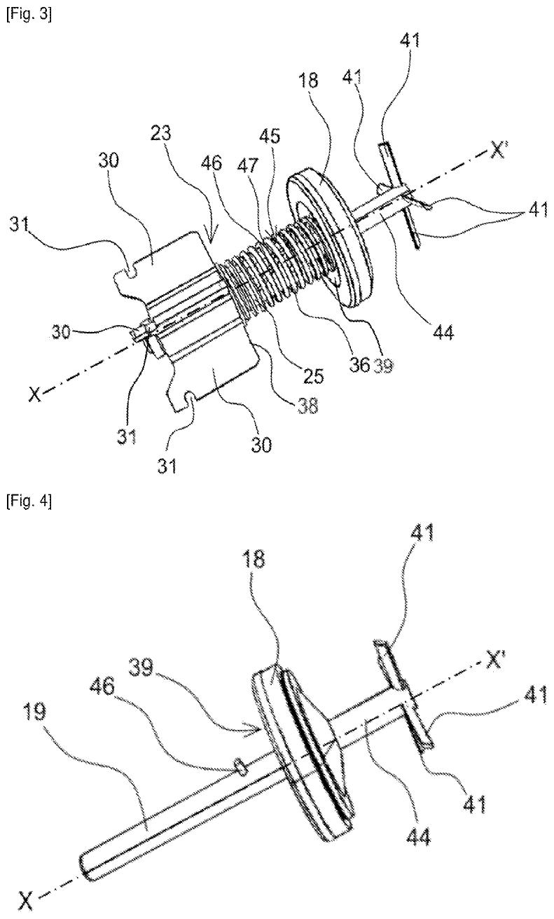

FIG. 3 is a perspective view of the internal components of the pressure valve according to the present invention;

FIG. 4 is a perspective view of the valve member of the pressure valve according to the present invention;

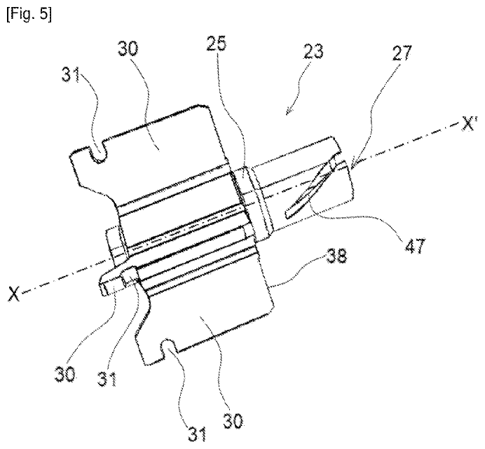

FIG. 5 is a perspective view of a guide for the pressure valve according to the present invention.

It should be noted that, in the figures, the structural and/or functional elements common to the different embodiments may have the same references. Thus, unless otherwise stated, such elements have identical structural, dimensional and/or material properties.

FIGS. 1a, 1b, 2a and 2b respectively represent perspective views from two different angles and in longitudinal section in a closed position and in an open position of a pressure valve 10 according to the present invention;

FIGS. 1a, 1b, 2a and 2b show the pressure valve 10 comprising a body 11 having a fluid inlet opening 12 and a fluid discharge opening 13.

A first end of the body 11 is located on the side of the inlet opening 12 and may be connected in particular to a fluid inlet (not shown), in particular a pipe, in particular a pipe in which air and/or fuel circulates. For this purpose, the first end of the body 11 may comprise a groove 16 capable of receiving a seal around which the fluid inlet is positioned, in particular the pipe in which air and/or fuel circulates. The fluid inlet may be held in place by means of a flange, a clamp or any other holding device suitable for the application.

A second end of the body 11 is located on the side of the discharge opening 13 and can be connected in particular to a fluid outlet (not shown), in particular a pipe, in particular a pipe in which air and/or fuel circulates.

According to an alternative (not shown), the second end of the body 11 may comprise a groove capable of receiving a seal around which the fluid outlet is positioned, in particular the pipe through which air and/or fuel circulates. The fluid outlet may be held in place by means of a flange, a clamp or any other holding device suitable for the application.

Alternatively, the second end of the body 11 may open into a fluid recovery volume, such as a tank. Such an arrangement is advantageously that shown in which no seal receiving groove is provided on the side of the fluid discharge opening 13.

A direction of circulation of the fluid inside the pressure valve 10 is indicated by the arrow F.

As illustrated in FIGS. 2a and 2b, the pressure valve 10 comprises a valve member 18 extending along an axis XX′ defining an axial direction. More specifically, the valve member 18 is provided with a rod 19.

Furthermore, the pressure valve 10 comprises a guide 23 for guiding the valve member 18 and a valve member seat 15 as support for receiving the valve member 18.

In such an arrangement, the valve member 18 is mounted so as to move in the axial direction of the axis XX′ relative to the body 11, in particular relative to the guide 23, between a closed position in which the valve member 18 bears against the valve member seat 15 and an open position in which the valve member 18 is spaced from the valve member seat 15. The valve member 18 is thus axially movable along the axis XX′.

More particularly, the valve member 18 has a disc shape extending radially relative to the rod 19. In addition, the valve member seat 15 is produced in the body 11.

In order to ensure the seal between the valve member 18 and the valve member seat 15, the valve member 18 may comprise a gasket 24, advantageously molded over a shoulder, as shown in FIG. 2b. The gasket 24 may be made from an elastomer material or another material suitable for the application. The choice of the material of the gasket 24 is made according to its compatibility with the fluid circulating inside the pressure valve 10. Alternatively, such a gasket 24 is however not essential, insofar as the seal can be ensured directly by a surface contact between the valve member 18 and the valve member seat 15, more particularly between a contact surface of the valve member 18 and a surface of the valve member seat 15, generating thereby a surface support.

The guide 23 is fixed in translation relative to the body 11.

For this purpose, according to the exemplary embodiment in FIGS. 2a and 2b and in FIGS. 3 and 5 which are perspective views of the internal components and more specifically of the guide 23 of the pressure valve 10 according to the present invention, the guide 23 comprises a sleeve 25 provided with a passage 27 which the rod 19 of the valve member 18 passes through. More specifically, the sleeve 25, preferably a tubular one, may consist of a cylindrical portion in which the rod 19 of the valve member 18 is inserted.

Additionally or optionally, bearings 26, such as annular ring-shaped bushes, may be arranged radially between an outer periphery of the rod 19 and an inner periphery of the sleeve 25.

At one of its ends, in particular a downstream end near the fluid discharge opening 13, the guide 23 may comprise a plurality of vanes 30. The plurality of vanes 30 contributes to maintaining the sleeve 25, and consequently the guide 23, in the pressure valve 10.

Ideally, the plurality of vanes 30 is arranged on an external periphery of the sleeve 25, in particular the vanes 30 are carried by an external periphery of the cylindrical portion forming the sleeve 25.

According to an exemplary embodiment, the vanes 30 extend in a radial projection in at least one plane containing the axis XX′ of the valve member 18. The vanes 30 advantageously have a small thickness, in particular of the order of a millimeter, so as not to hinder the circulation of the fluid inside the pressure valve 10.

As can be seen in FIGS. 1a, 3, and 5, each vane 30 comprises a notch 31, preferably a shallow one. The notch 31 may be provided for receiving a circlip 33, in particular of toric shape and in particular provided with a handling rim at its ends.

The circlip 33 is aimed to cooperate with a circumferential groove 34 of corresponding shape in an internal face of the body 11, as shown in FIGS. 2a and 2b. Such a configuration permits to keep the guide 23 fixed in translation relative to the body 11.

In the example shown, the guide 23 comprises four vanes 30, preferably arranged at an angle of 90 degrees between them. Of course, the number of vanes 30 may be less or greater than 4. This depends on the application, in particular the forces to be supported by the guide 23 when the pressure valve 10 is in operation. Preferably, the vanes 30 are distributed angularly in a regular manner along the external periphery of the guide 23. As illustrated in FIGS. 2a, 2b, and 3, a return spring 36 is arranged axially between the guide 23 and the valve member 18. According to the example shown, the return spring 36 is arranged around the rod 19 and the portion of the sleeve 25 extending axially beyond the vanes 30. The return spring 36 urges the valve member 18 against the valve member seat 15 in the closed position. The calibration of the return spring 36 enables to define the pressure threshold beyond which the pressure valve 10 goes from the closed position to the open position.

The guide 23 comprises a support 38 against which a downstream end of the return spring 36 bears. The support 38 may have an annular shape extending radially relative to the axis XX′ forming a support washer. The support 38 may be formed by upstream edges of the vanes 30 facing the valve member 18. Alternatively, the support 38 may be an added part bearing or pressed against the upstream edges of the vanes 30 facing the valve member 18. Such an arrangement permits to guarantee flat support of the return spring 36 on the side of the guide 23.

An upstream end of the return spring 36 bears against the valve member 18. According to such a particular embodiment, the valve member 18 comprises a housing 39 for receiving the upstream end of the return spring 36. The housing 39 has a diameter corresponding to a diameter of the return spring 36. The housing 39 is provided in an end face of the valve member 18 facing the vanes 30.

As can be seen in FIGS. 1b, 2a, 2b and 3 and in FIG. 4 which is a perspective view of the valve 16 of the pressure valve 10 according to the present invention, the pressure valve 10 further comprises at least one fin 41, in particular upstream of the valve member 18, for causing the valve member 18 to rotate when a fluid passes from upstream to downstream through the body 11 from the fluid inlet opening 12 to the fluid discharge opening 13.

In this case, the pressure valve 10 comprises a plurality of fins 41, advantageously angularly spaced from each other in a regular manner.

The fins 41 are carried by a pin 44, in particular on an upstream face of the valve member 18 facing the fluid inlet opening 12. The pin 44 extends along the axis XX′.

According to an alternative embodiment, the pin 44 can be an added part fixed to the upstream face of the valve member 18 facing the fluid inlet opening 12.

As shown in the figures, the rod 19, aimed to cooperate with the guide 23, and the pin 44, carrying the fins 41, extend on either side of the valve member 18, as more specifically shown in FIG. 4.

The valve member 18, the rod 19 and the pin 44 may form a single piece. Furthermore, the rod 19 and the pin 44 may be integral with the valve member 18 or may be added and fixed to a corresponding face of the valve member 18, in particular by screwing, gluing, welding or any other fixing technique suitable for the application.

The fins 41 can form a non-zero angle of incidence. Thus, the fins 41 are not contained in a plane perpendicular to the axis XX′ but form an angle with it. The angle of incidence of the fins 41 can be adapted according to the desired rotation speed of the valve member 18 as well as the desired torque on the pin 44.

In the example shown, the valve member 18 has four fins 41. Of course, the number of fins 41 may be less or greater than 4.

Alternatively, the fins 41 may be arranged directly on the face of the valve member 18 facing the fluid inlet opening 12. In such an arrangement, the pressure valve 10 does not include a pin 44.

In addition, the pressure valve 10 may comprise a guiding device 45, in particular visible in FIGS. 2a, 3, 4 and 5, for guiding the valve member 18 relative to the guide 23. In particular, the guiding device 45 allows to guide the valve member 18 relative to the guide 23 along a specific trajectory, in particular a helical trajectory. According to this arrangement, it is thus possible to transform a rotational movement of the valve member 18 into an axial displacement.

For this purpose, the guiding device 45 comprises a finger 46 mechanically connected to the rod 19 of the valve member 18 entering into cooperation with a guiding groove 47, in particular of helical shape, in the guide 23. The finger 46 extends in radial projection relative to an external periphery of the rod 19. The finger 46 is inserted into the guiding groove 47 in the sleeve 25 of the guide 23. The guiding groove 47 may radially extend through the wall of the sleeve 25 of the guide 23.

Alternatively, the structure may be reversed, i.e. the finger 46 may be mechanically connected to the guide 23 while the guiding groove 47 is carried out in the rod 19 of the valve member 18.

In another variant, the guiding device 45 may be carried out from a screw-nut connection in which a thread is provided on the rod 19 and a tapping of corresponding shape is provided in the internal face of the sleeve 25 of the guide 23. As can be seen in FIGS. 1a, 1b, 2a, and 2b, the body 11 may comprise fixing interfaces 50 with a structural element, such as a tank or a pipe. As a particular example, each fixing interfaces 50 may be formed by a projecting lug provided with an opening for the passage of a fixing member, such as a screw or a rivet or any other fixing member suitable for the application.

The pressure valve 10 is made from a metallic material, in particular aluminum. This avoids the risks of static electricity in an explosive environment.

Alternatively, in particular for an application without any particular danger linked to the presence of flammable and/or explosive fluid, the various components of the pressure valve 10 may be made from a plastic or composite material reinforced with glass or carbon fibers.

The operation of the pressure valve 10 according to the present invention is described below. When a fluid flows in the direction of flow F inside the pressure valve 10 initially in the closed position, as shown in FIG. 2a, the energy of the fluid coming into contact with the vanes 41 generates a force on the vanes 41, rotating thereby the valve member 18 due to the non-zero angle of incidence of the vanes 41. A torque is then applied by the fluid to the valve member 18, in particular to the pin 44. The guiding device 45 transforms the rotary movement of the vanes 41 into an axial displacement of the valve member 18. As a result, the finger 46 then moves inside the guiding groove 47 in a direction away from the seat of the valve member 18, while the return spring 36 is compressed. When the valve member 18 is fully open, as shown in FIG. 2b, the finger 46 abuts on an end edge of the guiding groove 47.

Once in abutment, the torque generated on the valve member 18, in particular on the pin 44, by the action of the fluid flow on the fins 41 permits to maintain the valve member 18 in the fully open position and prevents oscillatory phenomena from happening. When the pressure decreases on the side of the fluid inlet opening 12, the return spring 36 stretches out and pushes the valve member 18 towards the valve member seat 15. The finger 46 of the rod 19 then moves inside the guiding groove 47 so that the valve member 18 returns to the closed position, as shown in FIG. 2a. The finger 46 then comes into abutment on an opposite end edge of the guiding groove 47.

Of course, the different characteristics, variants and/or embodiments of the present invention can be associated with each other in various combinations insofar as they are not incompatible with or exclusive of one another.

Furthermore, the invention is not limited to the embodiments described above and provided solely by way of example. It encompasses various modifications, alternative forms and other variants which a person skilled in the art may envisage in the context of the present invention and in particular any combination of the various operating modes described above may be taken separately or in combination.

1. A pressure valve comprising:
a body having:
a fluid inlet opening; and
a fluid discharge opening,
a valve member provided with a rod mounted so as to move in an axial direction relative to the body between:
a closed position, in which the valve member bears against a valve member seat; and
an open position, in which the valve member is moved away from the valve member seat, and
wherein the pressure valve further comprises at least one fin upstream of the valve member for causing the valve member to rotate when a fluid passes from upstream to downstream through the body from the fluid inlet opening to the fluid discharge opening.
the pressure valve comprising a guide fixed in translation relative to the body and comprising a guiding device for guiding the valve member relative to the guide along a helical trajectory,
the guiding device comprising at least one finger mechanically linked to one of the elements selected from the rod of the valve member and the guide, and
the finger cooperating with a guiding groove of helical shape, made in the other of the elements selected from the rod of the valve member and the guide.

2. The pressure valve according to claim 1, further comprising a plurality of fins angularly spaced from each other in a regular manner.

3. (canceled)

4. (canceled)

5. The pressure valve according to claim 1, wherein the fin is carried by a pin arranged or fixed on a face of the valve member facing the fluid inlet opening.

6. The pressure valve according to claim 1, further comprising a plurality of vanes arranged on an outer periphery of the guide.

7. The pressure valve according to claim 6, wherein each vane has a notch allowing the passage of a ring aimed to cooperate with a circumferential groove of corresponding shape made in an internal face of the body so as to keep the guide fixed in translation relative to the body.

8. The pressure valve according to claim 1, wherein the guide carries a support against which one end of a return spring bears, in particular axially between the guide and the valve member.

9. The pressure valve according to claim 1, wherein the body comprises fixing interfaces.

10. The pressure valve according to claim 1, wherein it is made from a metallic material, especially aluminum.
